(19) United States
(12) Patent Application Publication
(10) Pub. No.: US 2023/0307006 A1
(43) Pub. Date: Sep. 28, 2023

(54) SYSTEM AND METHOD FOR EFFICIENT RECORDED SESSIONS OF ON-SCREEN ACTIVITY SAVING

(71) Applicant: Adusso Oy, Helsinki (FI)

(72) Inventors: Janne Petteri Pitkänen, Heisinki (FI); Matti Hermanni Pitkäranta, Hyvinkää (FI); Antti Kalevi Haapala, Oulu (FI)

(21) Appl. No.: 17/701,722

(22) Filed: Mar. 23, 2022

(51) Int. Cl. G11B 27/36; G11B 27/031; G06F 3/16

(52) U.S. Cl. CPC G11B 27/36; G11B 27/031; G06F 3/16

(57) ABSTRACT

The present disclosure is directed to a system and method for a recording user's on-screen activity and further storing thereof in an optimized manner that ensures conserving computer resources for data processing and, in the case of excessive computer resources use, exporting of processing activities to virtual machines. Allocation of memory resources is performed by a coordinate database that assigns data for the least utilized database unit. It is further combined with a method to resize and change the resolution of recorded content to the extent that it still enables OCR recognition.

### BACKGROUND OF THE INVENTION

### Field of the Invention

The present invention relates to the area of user activity monitoring of the on-screen performed actions. Screen recording remains one of the most important sources of information for evaluating usability and user experience. Reconstruction of on-screen activity may lead to inappropriate conclusions and as a consequence, recording of the screen in the as-is form remains one of the most reliable means of user experience monitoring.

### Description of the Related Art

Recording on-screen activity is a side functionality of the system as the core element of operations is the application itself that operates either on-site or on the server and consequently, the process of the recording should remain the least intrusive towards the functioning of the application as possible.

Currently known prior art fails to bring the solution that responds to the need for efficient and accessible screen activity recording in the as-is form that would enable faster access to data with no excessive exploitation of computer resources providing a comprehensive system of such data storage both on-site and on a virtual machine.

### BRIEF SUMMARY OF THE INVENTION

The present invention relates to an apparatus for user activity monitoring in the as-is form including the potential use for user experience monitoring, the apparatus comprising an output capture module for capturing at least one type of output, an input capture module for capturing at least one type of input, a user trigger capture module for capturing at least one type of test user trigger, and at least one storage module for saving at least some of the captured events.

The present disclosure is directed to the evaluation of the user's on-screen activity while using the application by a recording of the on-screen activity. The disclosed system and method are directed towards user experience monitoring by an efficient user screen recording module that covers capturing inputs and outputs.

Currently, user interaction recording remains one of the most important elements of assuring usability with software applications, and to enable a real assessment of user experience, the system operator should be able to observe the real interaction between the application and the user. It is further disclosed, that both method and system are designed in a way that ensures efficient use of computer and server resources not to hinder computer operating as well as application accessibility.

The disclosed invention is designed in a way that enables the recording of the on-screen activity of both on-computer installed applications, mobile applications as well as applications configured on a server with views streamed to the user's processor (virtualized applications).

The disclosed invention focuses on the aspect of reserving the processor resources to the extent that enables no excessive load on the computer functioning as well as further processing on the virtual machines that store recorded sessions.

### BRIEF DESCRIPTION OF THE SEVERAL VIEWS OF DRAWING

Further advantages features and details of the various embodiments of this disclosure will become apparent from the ensuing description of a preferred exemplary embodiment or embodiments and further with the aid of the drawings. The features and combinations of features recited below in the description, as well as the features and feature combination shown after that in the drawing description or in the drawings alone, may be used not only in the particular combination recited but also in other combinations on their own without departing from the scope of the disclosure.

Advantageous embodiments of the invention are explained below with reference to the accompanying figures, wherein:

FIG. 1 depicts a simplified connection scheme regarding communication between first user processor, server and virtual storage;

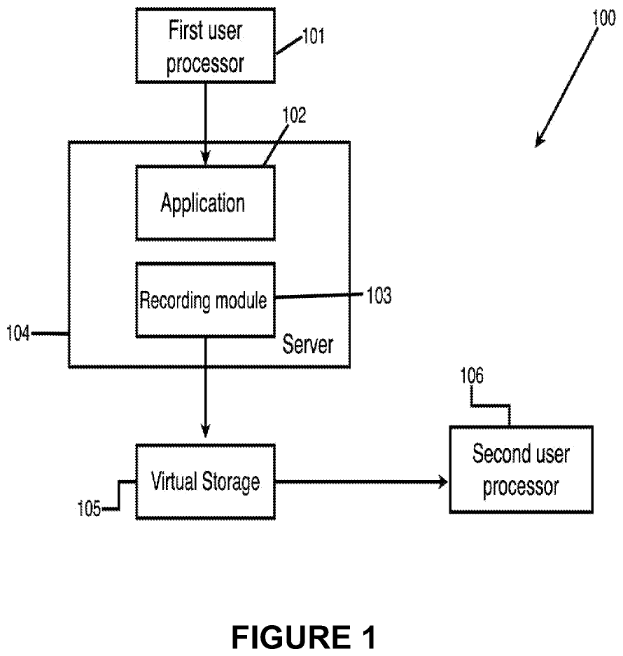

FIG. 2 depicts a scheme of elements recorded on the processor of the first user and virtual storage;

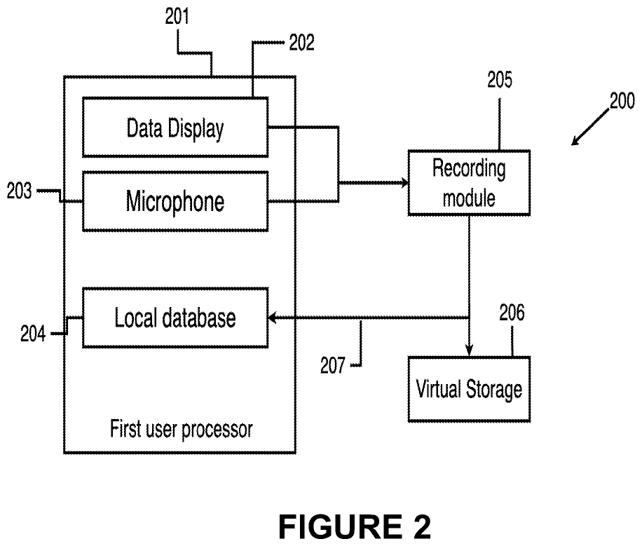

FIG. 3 depicts a detailed scheme of first user processor recording with saving process allocated on virtual storage units and local storage;

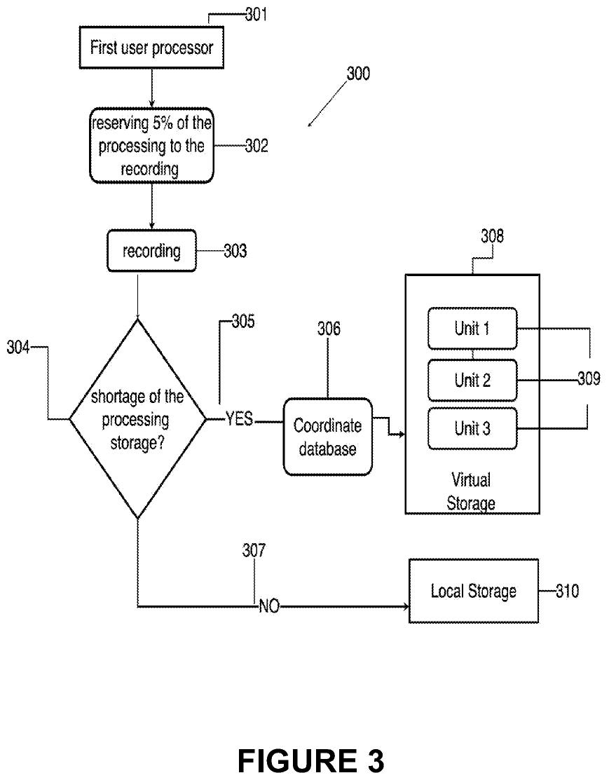

FIG. 4 depicts a detailed scheme of first user processor recording with saving process managed by the coordinate database;

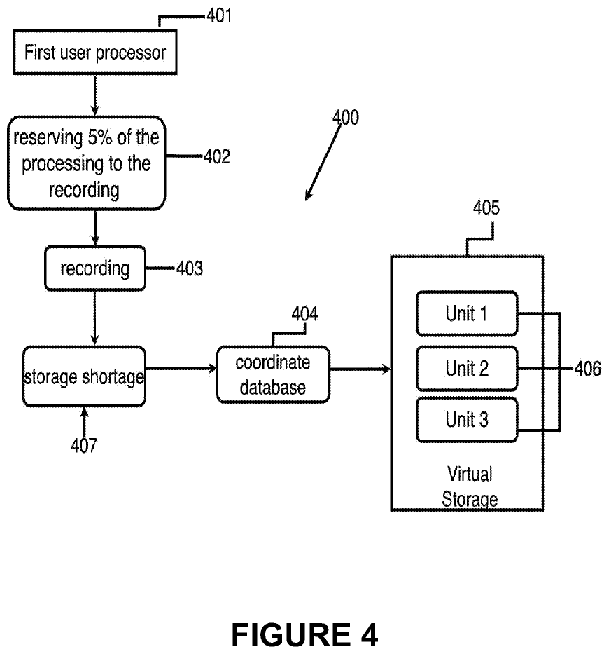

FIG. 5 depicts a detailed scheme of the recording process on the first user processor connected with the recording module and virtual storage;

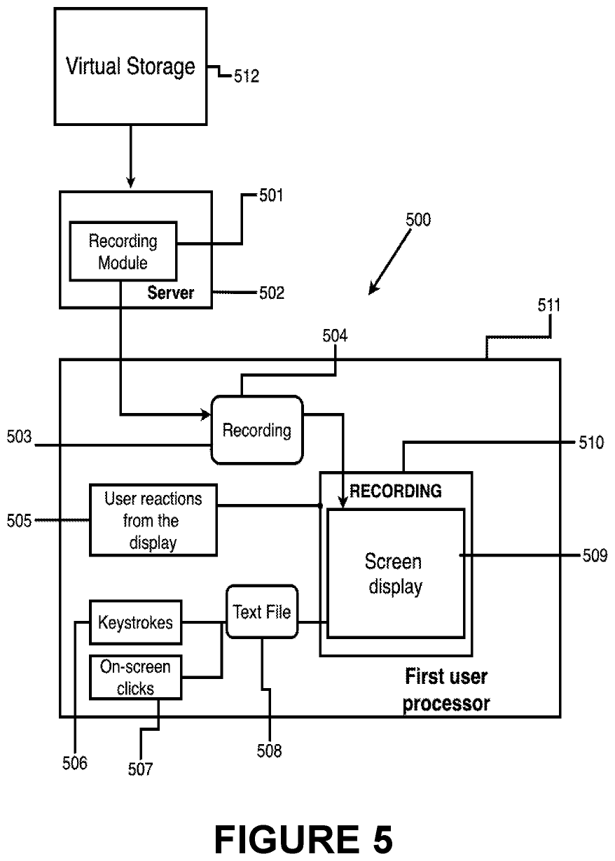

FIG. 6 depicts a detailed scheme of first user processor recording with saving process managed by the coordinate database with the removal of excessive content; and

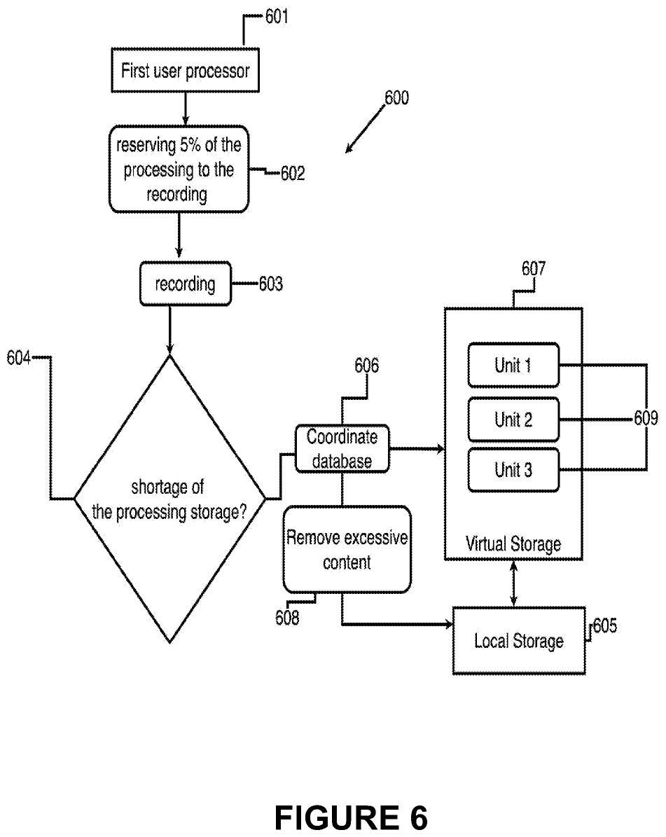

FIG. 7 depicts a flow of data with content optimization regarding changing of frame size and resolution adjustment.

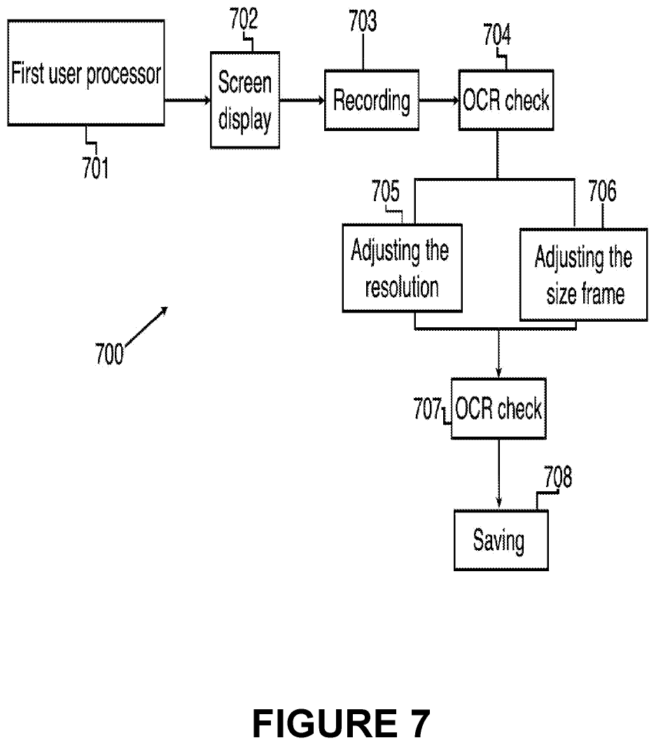

### DETAILED DESCRIPTION OF THE INVENTION

As used throughout the present disclosure, unless specifically stated otherwise, the term “or” encompasses all possible combinations, except where infeasible. For example, the expression “A or B” shall mean A alone, B alone, or A and B together. If it is stated that a component includes “A, B, or C”, then, unless specifically stated otherwise or infeasible, the component may include A, or B, or C, or A and B, or A and C, or B and C, or A and B and C. Expressions such as “at least one of” do not necessarily modify an entirety of the following list and do not necessarily modify each member of the list, such that “at least one of “A, B, and C” should be understood as including only one of A, only one of B, only one of C, or any combination of A, B, and C. In the figures, the same or functionally identical elements have been provided with the same reference signs.

The disclosed invention is an apparatus and method for testing usability and more precisely for the monitoring of the user on-screen activity in the as-is form. The system of the invention is characterized in that the user trigger capture module and the storage module are connected to an object to be tested independently thereof. The present invention is generally directed to the problem of using information originating from the recording sessions. While many emergent problems are easy to detect by the users, they are difficult to trace back without a sufficient recording of the user's interaction with their respective computer systems and/or networks upon which such systems operate.

User activity traces remains one of the most important ways to check how the user interacts with the software. To ensure understandability it is necessary to observe the detailed activity of the user to the viewed interface. In this regard, screen recording serves a very valuable source of knowledge about user experience. Currently, there are two most used ways of screen recording namely, real-time screen recording that produces a video clip of the display and event-based reconstruction of the display based on the data stored by the backend infrastructure. Only the former method provides a real possibility to view what the user observed on the screen including errors or system flaws.

Consequently, to evaluate the real impact of the system on user activity it is necessary to record storage-consuming sessions of the display and user interactions that shall be further stored. Such monitoring activity may lead to the hindrance of application fluency and the disclosed invention provides a system and method steps that adjust the functioning of data saving in this regard.

The present invention focuses on the improvement of how recorded sessions are being stored. The recording module is configured to record the as-is on-screen user activity. As a consequence, every element of the display that is viewed by the first user is also recorded by the recording module. The process starts with the processor of the first user (101) where the first user interacts with the application that is recorded. Application (102) is installed on the server (104) and interaction between the first user and the application is recorded by the recording module (103) installed on the server (104) as well. Actions recorded by the recording module are further sent to store to the virtual storage (105) and may be displayed on the processor of the second user (106).

The recording module (205) is arranged on the server and further records the display of the first user screen (202) or other content (203) regardless of the fact that the application used by the first user operates on the processor or is streamed to the processor by the server. The content is recorded on the first user processor (201). The recording of the display of the first user is divided into clips and further saved in the local storage (204). In case of the local storage shortage, the system enables the first user processor to communicate with the virtual storage (207) and to send the data of the recorded content recorded by the recording module (205) in the virtual database (206).

The recording of the processor of the first user (301) may be saved in the scope of local storage predefined by the first user on the processor (302). To ensure that the amount of local storage is enough to maintain proper functioning of the observed application, the disclosed system and method steps enable the user to reserve the amount of processing power on the processor of the first user. The user may for example dedicate 5% (302) of the processing power of the computer to process and store the recording. In such a case, when the recording begins (303), the system checks if there is a shortage of processing storage (304). If there is a shortage (305), the system is prepared to communicate with the coordinate database (306) that shall assign the saving process to the adequate storage unit (309) located in the virtual storage (308). If there are only limited resources needed to save recorded content and there is no shortage (307), the system is prepared to store recorded content locally. In such a situation, the disclosed invention would limit its exploitation of the computer processing power only to the extent defined by the limit. The aim of such a limit is to ensure that the core functionality of the computer as well as the application that is under the recording process function properly. The disclosed system and method steps are dedicated to creating the least possible pressure on utilizing the computer processing power.

If the use of dedicated processing power exceeds (407) the settled limit the processing and storage shall be exported to the external memory located on a physical or virtual machine. Depending on the volume of the recorded content (403) and the volume of processing dedicated to the recording storage (402) on the processor of the first user (401), the content may be stored on a server or on a plurality of virtual machines to secure the processing resources of the first user processor (401). Assignment of the recorded content to the storage units is performed by the coordinate database (404) which decides about the assignment of the recorded content to the least utilized storage unit (406) constituting the virtual storage (405).

To ensure that recorded content will not encounter any loss of data, the data shall be exported to the coordinate database and then saved accordingly in real-time. Consequently, the processor of the first user utilizes only the usage of processing power that is necessary to uphold the recording process and the data shall be assigned to the accessible storage unit repetitively upon the condition of the least utilized storage unit.

The system is therefore provided with an arrangement for safeguarding a time-link storage capability without affecting the number of resources available to the object to be recorded. If the display is to be recorded on a computer program the capturing is not discontinued due to tilting of the computer and/or its restart—the recording remains ongoing as long as the user is actively acting on the screen. The disclosed system and method ensures to save the recorded clips in a real-time manner as those being recorded and to ensure that the resources for the recorded clips are being secured both on the local storage of the processor as well as on the virtual machine. Furthermore, the object to be recorded is not affected in any way, i.e. its operation does not slow down nor does its stability suffer, or the progress of its performance change in any way due to the test arrangement which remains the core element of the invention.

The disclosed invention allows avoiding for example a computer program integrated into the object under study (recording) or a background process for storing and sending log data. The disclosed invention makes it possible to obtain information of situations of use that would otherwise not have been possible to define or the examination of which would be too laborious. The storage system as such does not disturb the situation of use.

The disclosed invention includes the possibility of recording all potential on-screen activities and further storing such recordings. On-screen activity (509) recorded on the processor of the first user (510, 511) includes user interaction with the display (505), keystrokes (506) and on-screen clics (507). It further records all textual elements (508) displayed on the screen of the first user. Recording (504) is performed by the recording module (501) arranged on server (502) and is further configured to communicate with the virtual storage (512) that includes coordinate database that further assigns recording to the least utilized unit.

The present invention is also designed to enable automatic removal of excessive recordings. Once the recording is collected on the processor of the first user (601) and there is a limit of up to 5% of processing power of the processor to be utilized for recording processing and storage (602), then, in the case of recording (603) utilizes excessive use of the processing power (604), the recording is saved in the virtual storage (607). Saving in the virtual storage (607) is coordinated by the coordinate database (606) that decides about the storage unit to save the content (609). Virtual storage (607) is further arranged to communicate with the local storage (605) and remove excessive data (608) from the local storage (605) in case of processing being outsourced to the virtual storage (607).

Furthermore, the disclosed invention automatically enables the changing of the resolution or size-frame of the recorded content to optimize the size of the recorded file. In case the content (702) recorded (703) on the first user processor (701) displays plain text or other content that does not require high image resolution and the lower resolution will not hinder the OCR analysis (704), the system and method steps are directed towards the resolution (705) adjustment to the extent that it optimizes unnecessary high-end display quality to store only the information that remains necessary for the optical analysis. Analogous steps are included in the case of frame resizing (706) that shall lower the size of recorded content and as a consequence save processing power. In this regard, the benchmark for the size of the frame would be again defined by the ability of OCR-based systems to analyze the content (707). If the check by the OCR-based qualifier is positive the content is being saved (708) in a resized resolution or adjusted frame size.

The process of configuration of the amount of processing memory (802) begins on the processor of the first user (801). Then the method step is further configured to record the on-screen activity on the second user processor (805). Afterwards the disclosed method steps check the amount of the processing power (806) to decide if the amount is enough to keep to proper functioning of the observed application. Recorded content is saved in the database (804) and further transferred to the virtual storage (805).

Having described some aspects of the present disclosure in detail, it will be apparent that further modifications and variations are possible without departing from the scope of the disclosure. All matter contained in the above description and shown in the accompanying drawings shall be interpreted as illustrative and not in a limiting sense.

What is claimed is:

1. A system for saving recorded sessions of on-screen activity, the system comprising:
at least one first user processor configured to use a network connection in communication with a server;
a recording module configured to record on-screen display and content processed on the first user processor and arranged on the server;
virtual storage configured to store the sessions from the first user processor arranged on the server;
at least one second user processor comprising a service display, the at least one second user processor configured to display recorded content collected by the recording module and arranged to use the networked connection in communication with the server;
wherein, the server in communication with the processor of the first user where the virtual storage is arranged constitutes a dedicated server; and
wherein the virtual storage is configured to save the content that exceeds the programmed storage limit configured on the processor of the first user.

2. The system according to claim 1, wherein the first user processor further comprises:
a data display configured to display a plurality of types of content including text, graphic elements, and audiovisual content;
a microphone configured to record sound within a vicinity of the first user processor;
a local database arranged on first user processor configured to save content displayed on the data display; the local database further comprising storage configured to save the content collected by the recording module; and
wherein the data display is further configured to display the content in a native resolution as well as scaled display configurations;

3. The system according to claim 1, wherein the recording module further comprises:
an interface recorder configured to record screen display on the processor of the first user; and
wherein the interface reader is further configured to capture tapping into first user inputs with a keyboard and mouse for both virtual and non-virtual keyboard and computer mouse.

4. The system according to claim 1, wherein the virtual storage further comprises:
at least one virtual storage server configured to store the data sent to the virtual storage by at least one of the first user processors or recording modules; and
a coordinate database arranged on the virtual storage server and configured to distribute recorded clips to the virtual storage.

5. The system according to claim 1, wherein the second user processor further comprises:
at least one data display configured to display the recorded sessions of the first user activity to the second user;
a data input configured to edit the recorded sessions of the first user activity to the second user; and
wherein editing of recorded sessions includes changing resolution, removing its parts.

6. A method for saving recorded sessions of on-screen activity, the method comprising the steps of:
configuring the amount of processing memory to be used by the first processor to save the recorded content;
recording on-screen activity of a first user by the recording module arranged in communication with the server;
recording the content by the microphone arranged on the first user processor;
saving the content displayed on the data display in the local database storage arranged on the first user processor;
saving the content recorded by the microphone operating on the first user processor by the recording module;
checking the amount of processing memory that is still available on the processor of the first user;
sending the recorded content to the virtual storage arranged on the server; and
wherein sending the recorded content to the virtual storage is configured in a real-time saving speed.

7. The method according to claim 6, further comprising the steps of:
recording all content displayed on the first user display;
recording press keys on the keyboard in the form of timestamped event with no letter definition; and
recording other keystrokes at least of function keys and their combinations as is displayed on the screen.

8. The method according to claim 6, further comprising the steps of:
reserving the amount of processing memory on the first user processor by the first user to be utilized by the recording;
using the reserved amount of processing memory only to the extent necessary to utilize recording;
sending recorded content to assign the adequate storage unit by the coordinate database;
saving recorded content by the coordinate database on the dedicated virtual machine; and
wherein the recorded content includes recorded first user display; and
wherein the reserved amount of processing memory is reserved to the extent that it does not hinder the functionality of a recorded application.

9. The method according to claim 6, further comprising the steps of:
reserving the amount of processing memory that ensures fluent functioning of the processor;
exporting recorded content to the server in case of insufficient resources on the processor of the first user in real-time; and
removing recorded content from the processor of the first user after the content is transferred to the server;

10. The method according to claim 6 further comprising the steps of:
sending the content to the coordinate database;
assigning the content sent by the first user processor to the coordinate database to the storage unit;
assigning the content sent by the server to the coordinate database to the storage unit;
reassigning the content to save by the coordinate database to the storage unit upon incoming new data; and
wherein the new data can be assigned to the same or different storage unit depending on the storage resources.

11. The method according to claim 6, further comprising the steps of:
adjusting the resolution of the recorded content to store more content by one storage unit;
adjusting the size frame of the recorded content to store more content by one storage unit; and
wherein the size of the stored content and resolution enable OCR analysis.
